(19) United States
(12) Patent Application Publication
(10) Pub. No.: US 2024/0089712 A1
(43) Pub. Date: Mar. 14, 2024

(54) DATA COLLECTION DEVICE, SENSOR TERMINAL, METADATA COLLECTION SYSTEM, METADATA COLLECTION METHOD, AND PROGRAM

(71) Applicant: Nippon Telegraph and Telephone Corporation, Tokyo (JP)

(72) Inventors: Shinya TAMAKI, Musashino-shi, Tokyo (JP); Ryota SHIINA, Musashino-shi, Tokyo (JP); Tetsuya SUZUKI, Musashino-shi, Tokyo (JP); Yasutaka KIMURA, Musashino-shi, Tokyo (JP); Tomohiro TANIGUCHI, Musashino-shi, Tokyo (JP); Sei KOU, Musashino-shi, Tokyo (JP); Tomoya HATANO, Musashino-shi, Tokyo (JP); Takashi YAMADA, Musashino-shi, Tokyo (JP)

(21) Appl. No.: 18/271,373

(22) PCT Filed: Jan. 8, 2021
(86) PCT No.: PCT/JP2021/000428

§ 371 Date: Jul. 7, 2023

(51) Int. Cl. H04W 4/38

(52) U.S. Cl. CPC H04W 4/38

(57) ABSTRACT

An object is to provide a data collection device and the like capable of reducing a load on an IoT terminal in metadata transmission and power consumption associated with the metadata transmission.

In the present invention, a controller is provided on a data collection side that collects metadata, the metadata transmitted from an IoT terminal is grasped, and the IoT terminal is instructed to reduce the transmission frequency of metadata that does not need high real-time property according to a sensor, the type of the IoT terminal, or the like. The IoT terminal transmits the metadata only at a window time (transmission timing, data size, metadata type, or the like) permitted by the metadata controller. As a result, the IoT terminal transmits the metadata only at a limited timing, and thus can reduce a transmission load and power consumption.

### TECHNICAL FIELD

The present disclosure relates to sensing data collection in Internet of things (IoT).

### BACKGROUND ART

In recent years, services utilizing IoT sensors have been spreading. In analysis and utilization of sensing data, a state of a sensor, an installation situation of the sensor, or the like affects data accuracy. For this reason, collecting and utilizing information other than main sensor data of a measurement target acquired by an IoT terminal (sensor terminal) (the information is data such as a model, an installation location, or a connection status. Hereinafter, such data is described as “metadata”) leads to improvement of reliability of the sensing data. For example, Non Patent Literature 1 discloses a metadata collection technique utilizing a low-layer communication protocol for improving data reliability and simplifying operation management.

### CITATION LIST

### Non Patent Literature

Non Patent Literature 1: Tamaki et al., “Proposal of Low Layer Metadata Collection Method for IoT Data Trustworthiness”, The 2020 IEICE General Conference, B-8-16, March 2020.

### SUMMARY OF INVENTION

### Technical Problem

However, the metadata collection technique as in Non Patent Literature 1 has a problem that it is difficult to reduce a load on an IoT terminal in metadata transmission and power consumption associated with the metadata transmission. Therefore, in order to solve the above problem, an object of the present invention is to provide a data collection device, a sensor terminal, a metadata collection system, a metadata collection method, and a program capable of reducing a load on an IoT terminal in metadata transmission and power consumption associated with the metadata transmission.

### Solution to Problem

In order to solve the above problem, in the present invention, a controller is provided on a data collection side that collects metadata, the metadata transmitted from an IoT terminal is grasped, and the IoT terminal is instructed to reduce the transmission frequency of metadata that does not need high real-time property according to a sensor, the type of the IoT terminal, or the like. The IoT terminal transmits the metadata only at a window time (transmission timing, data size, metadata type, or the like) permitted by the metadata controller. As a result, the IoT terminal transmits the metadata only at a limited timing, and thus can reduce a transmission load and power consumption.

Specifically, a data collection device according to the present invention is a data collection device that collects metadata transmitted by a sensor terminal, the data collection device including a controller that indicates, to the sensor terminal, a transmission frequency for each type of the metadata on the basis of types of the metadata.

Meanwhile, a sensor terminal according to the present invention is a sensor terminal that transmits metadata to a data collection device, the sensor terminal including a transmission unit that makes a frequency of the transmission different for each kind of the metadata according to a transmission frequency for each kind of the metadata indicated by the data collection device.

Furthermore, a metadata collection system according to the present invention includes the data collection device and the sensor terminal.

The metadata collection system performs a metadata collection method for collecting metadata transmitted by the sensor terminal.

The metadata collection method includes: indicating, to the sensor terminal, a transmission frequency for each type of the metadata on the basis of types of the metadata; and making a frequency at which the sensor terminal transmits the metadata different for each type of the metadata.

Note that, in order to analyze what kind of metadata is collected, the controller may not indicate, to the sensor terminal, the transmission frequency for a certain period of time.

Furthermore, the transmission unit may discard the metadata that has failed to be transmitted to the data collection device.

The present invention provides a program for causing a computer to function as the data collection device. The data collection device of the present invention can also be implemented by a computer and a program, and the program can be recorded in a recording medium or provided through a network.

Note that the above inventions can be combined as much as possible.

### Advantageous Effects of Invention

The present invention can provide a data collection device, a sensor terminal, a metadata collection system, a metadata collection method, and a program capable of reducing a load on an IoT terminal in metadata transmission and power consumption associated with the metadata transmission.

### BRIEF DESCRIPTION OF DRAWINGS

FIG. 1 is a diagram for describing a metadata collection system according to the present invention.

FIG. 2 is a diagram for describing a sensor terminal according to the present invention.

FIG. 3 is a diagram for describing an example of a control signal transmitted by a data collection device according to the present invention.

FIG. 4 is a diagram for describing the data collection device according to the present invention.

FIG. 5 is a diagram for describing a relationship between types of metadata and transmission frequencies included in the data collection device according to the present invention.

FIG. 6 is a diagram for describing a metadata collection method according to the present invention.

FIG. 7 is a diagram for describing the data collection device according to the present invention.

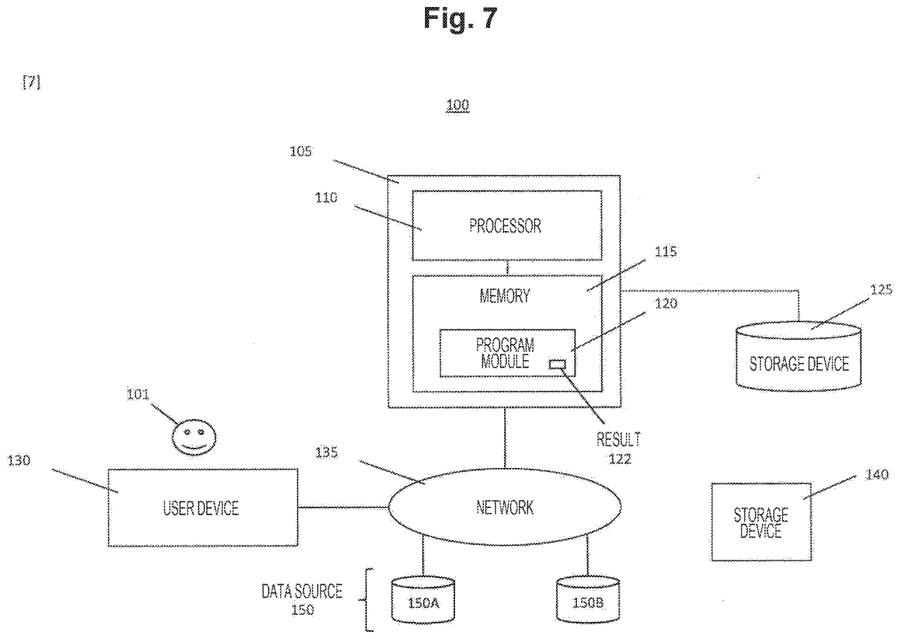

### DESCRIPTION OF EMBODIMENTS

Embodiments of the present invention will be described with reference to the accompanying drawings. The embodiments described below are examples of the present invention, and the present invention is not limited to the following embodiments. Note that components having the same reference signs in the present specification and the drawings indicate the same components.

### First Embodiment

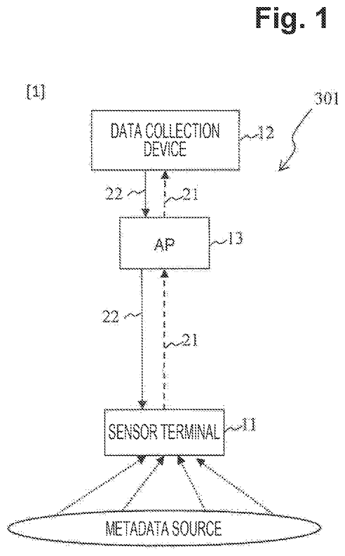

FIG. 1 is a diagram for describing a data collection system 301 according to the present embodiment. The data collection system 301 includes a sensor terminal 11 and a data collection device 12. FIG. 1 illustrates one sensor terminal 11, but a plurality of sensor terminals may be provided. The sensor terminal 11 acquires data 21 including main sensor data and metadata, and transmits the data 21 to the data collection device 12. The data collection device 12 transmits a control signal 22 indicating a transmission frequency according to the type of the metadata to the sensor terminal 11.

Note that the sensor terminal 11 and the data collection device 12 are connected by, for example, a communication network such as a local area network (LAN), a field area network (FAN), or an IoT area network. The sensor terminal 11 and the data collection device 12 may communicate with each other via an access point 13. In addition, the access point 13 may exist in the data collection device 12.

Examples of a communication protocol include various protocols for data communication such as wireless communication (Wi-Fi, LPWA), communication using conductive wire (Ethernet (registered trademark), PLC, single pair Ethernet), and communication using optical fiber (Ethernet, PON), various protocols for collecting device information such as LLPD, and home network protocols such as HTIP. Furthermore, the communication protocol used in the communication network may be a single type or a plurality of types.

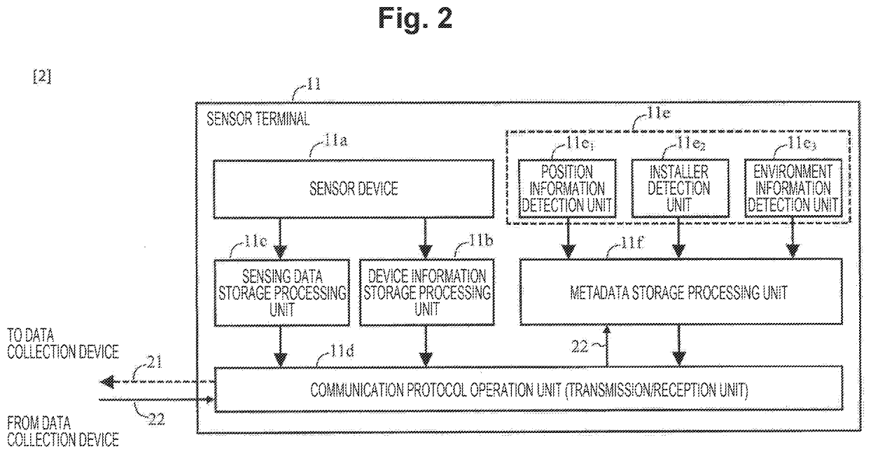

FIG. 2 is a block diagram for describing the sensor terminal 11.

The sensor terminal 11 includes a sensor device 11a, a device information storage processing unit 11b, a sensing data storage processing unit 11c, a protocol operation unit 11d, a detection unit 11e, and a metadata storage processing unit 11f. The sensor device 11a performs sensing regarding an object to be observed. The device information storage processing unit 11b collects device information on the object to be observed (for example, a manufacturer name, a model name, a model number, or the like of the device) and stores the information at a predetermined position of a frame (area that can be used for unique applications, such as an “extended area” or an “optional area” defined by the protocol). The sensing data storage processing unit 11c stores the sensing data from the sensor device 11a at a predetermined position of a frame (such as a payload portion defined by the protocol).

The detection unit 11e acquires information other than the device information (metadata). In the present embodiment, the information other than the device information is position information, installer information, and environment information of an object to be detected. However, the present invention does not limit the information other than the device information to these pieces of information. The detection unit 11e includes a position information detection unit 11e₁, an installer detection unit 11e₂, and an environment information detection unit 11e₃ in order to acquire these pieces of information. The position information detection unit 11e₁ is, for example, a GPS, an acceleration sensor, a gyro sensor, or an RSSI receiver for a Wi-Fi signal, a BLE beacon signal, or the like. The installer detection unit 11e₂ is, for example, a fingerprint sensor, a vein sensor, a camera (face recognition or iris recognition), or a microphone (voiceprint detection) in a case of identifying an installer, and is a receiver that receives an output value of a sensor worn by the installer (blood pressure, heart rate, moving speed, speech, conversation, or the like) in a case of confirming the situation of the installer. The environment information detection unit 11e₃ is, for example, a camera (image information) or an environment sensor that detects temperature, humidity, illuminance, atmospheric pressure, sound, infrared rays, ultraviolet rays or the like.

Note that the detection unit lie may detect all of a plurality of objects to be detected or may detect any one of the objects to be detected.

The metadata storage processing unit 11f stores the data detected by the detection unit lie as metadata in an extended area or an optional area in a frame set by the communication protocol.

The protocol operation unit (transmission/reception unit) 11d transmits the frames in which the sensing data and the device information are stored in the predetermined areas and the metadata is stored in the extended area or the optional area, which serve as the data 21, to the data collection unit 12. Note that the communication protocol of the frame in which the sensing data is stored and the communication protocol of the frame in which the device information is stored may be the same or different. In the latter case, the metadata storage processing unit 11f may store the metadata in the frame of any one of the communication protocols (the frame in which the sensing data is stored or the frame in which the device information is stored), or may store the metadata in the frames of both the communication protocols (the frame in which the sensing data is stored and the frame in which the device information is stored).

Furthermore, the protocol operation unit (transmission/reception unit) 11d receives the control signal 22 from the data collection device 12.

The metadata storage processing unit 11f may process the metadata such that the metadata conforms to the form or restriction of the unique extended area of the frame and then store the metadata in the frame. For example, the metadata storage processing unit 11f may convert the metadata into a certain shortened code and store the shortened code, or divide (fragment) the metadata into a plurality of frames and store the frames.

The metadata storage processing unit 11f can arbitrarily set a storage timing at which the metadata is stored in the frame. For example, the metadata storage processing unit 11f may set the storage timing such that the metadata is stored each time the metadata is updated, or may store the metadata at a timing when the metadata is accumulated for a certain period of time, instead of sequentially storing the metadata. Furthermore, in the case where the metadata is accumulated for a certain period of time, the metadata storage processing unit 11f may store a record (log) of the accumulation or a result obtained by performing specific calculation or statistical processing in the frame.

The type and storage timing of the metadata to be stored in the frame may be fixed or varied. The type and storage timing of the metadata may be dynamically changed by determination of the sensor terminal 11 itself or an instruction (control signal 22) from the data collection device 12. A specific description will be given. There are many types of metadata as described above (for example, the location, the installer, the inclination, the radio wave condition, the acceleration, the temperature, the humidity, and the voltage of the sensor terminal, a person near the sensor terminal, and the like). It is not necessary to transmit all pieces of metadata indicating these pieces of information at the same timing. For example, while metadata indicating the acceleration is transmitted in units of milliseconds, metadata indicating the voltage, metadata indicating the temperature and the humidity, and metadata indicating the location are only required to be transmitted in units of seconds, minutes, and hours, respectively. In addition, metadata indicating the installer does not need to be periodically transmitted, and the metadata is only required to be transmitted when an event occurs (for example, at the time of installation work, immediately after power is turned on, at the time of a change in location).

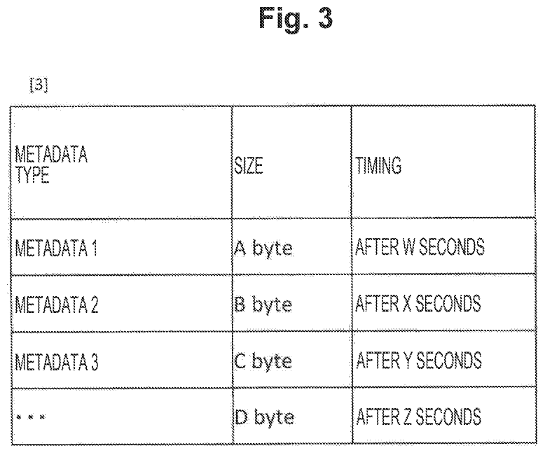

FIG. 3 is a diagram for describing the contents of the control signal 22. As illustrated, the control signal 22 describes a permission window of a transmission timing, a transmittable data size, a time slot, a metadata type, and a transmission method (a low layer, an application layer, or the like) for each type of metadata.

The sensor terminal 11 transmits the metadata according to the permission window of the control signal 22. For example, the sensor terminal 11 may transmit corresponding metadata (response) each time an instruction (request) of the control signal 22 is made, or may continue to periodically transmit metadata according to information such as a “metadata type” or a “transmission frequency” of the control signal 22.

Since the sensor terminal 11 transmits the metadata only at a limited timing, a load and power consumption can be reduced. Note that the sensor terminal 11 discards metadata acquired at a timing other than the timing.

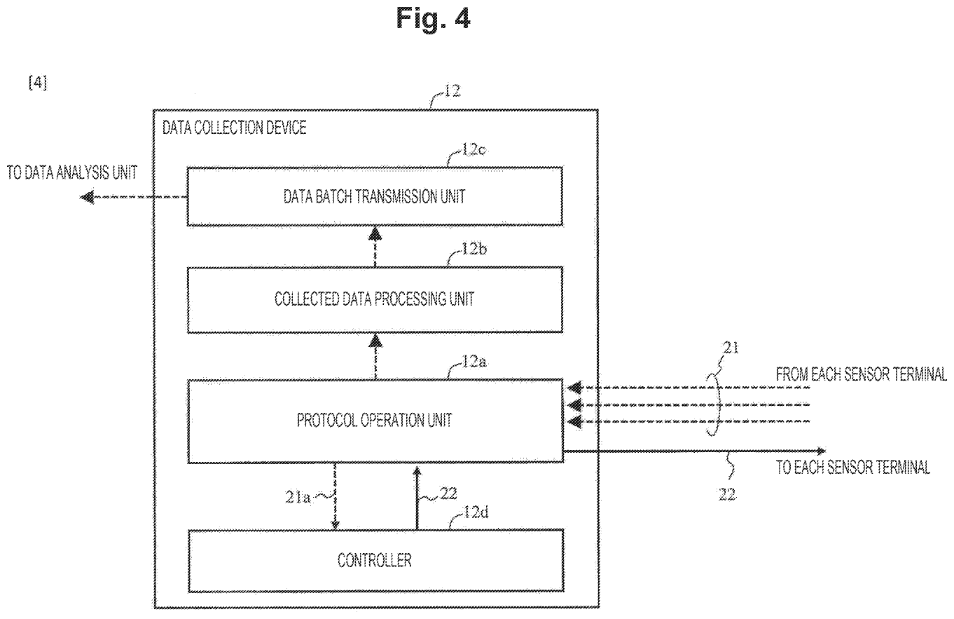

FIG. 4 is a diagram for describing the data collection device 12.

The data collection unit 12 includes a protocol operation unit 12a, a collected data processing unit 12b, a data batch transmission unit 12c, and a controller 12d. The protocol operation unit 12a receives the frames (data 21) in which the sensing data is stored and the metadata is stored in the unique extended area from the sensor terminal 11. The collected data processing unit 12b extracts the sensing data, the device information, and the metadata from the received frames, and organizes these in a database on the basis of information for identifying the individual sensor terminal 11 (for example, MAC address). The data batch transmission unit 12c stores the data organized in the database in a payload portion of a frame at a predetermined timing, and transmits the frame to a data analysis unit (not illustrated). The data batch transmission unit 12c may transmit only a part of the data in the database or may transmit all the data according to a requirement of the data analysis unit.

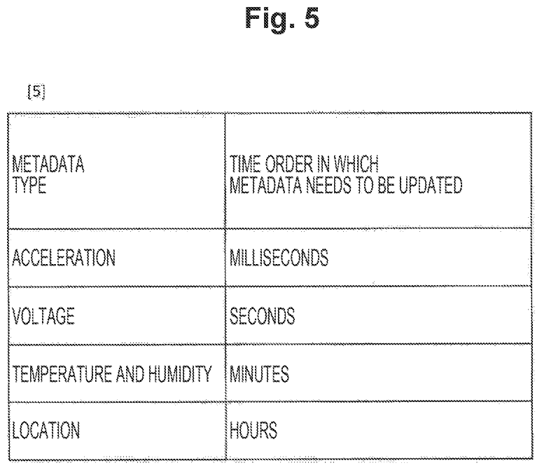

The controller 12d outputs the control signal 12 described above. The protocol operation unit 12a transmits the control signal 12 to each sensor terminal. The controller 12d has a relationship between types of metadata and time orders (transmission frequencies) in which the metadata needs to be updated as illustrated in FIG. 5. The controller 12d transmits the control signal 22 on the basis of the relationship as illustrated in FIG. 5. For example, the control signal 22 may be a transmission instruction (request) of a desired type of metadata as illustrated in FIG. 3, or may be information itself such as a “metadata type” or a “transmission frequency” as illustrated in FIG. 5.

As described above, in the metadata collection system 301, the data collection unit 12 can reduce the frequency at which the sensor terminal 11 transmits metadata that does not need high real-time property.

A worker may set the relationship as illustrated in FIG. 5 in the data collection device 12 in advance.

Note that, at an initial stage (for example, when the metadata collection system 301 is newly installed), metadata 21a may be collected from the sensor terminal 11 at the transmission frequency of the sensor terminal 11 without the control signal 22 being output even if the power consumption may be somewhat sacrificed. The types of the metadata may be analyzed when the controller 12d collects a certain amount of metadata, and the transmission frequencies according to the types of the metadata may be determined (performed by the worker or the data collection device 12).

In this case, even if main communication is not established between the data collection device 12 and the sensor terminal 11, the sensor terminal 11 can transmit metadata such as position information in a low layer such as a beacon.

### Second Embodiment

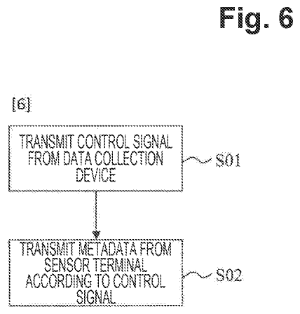

FIG. 6 is a flowchart for describing a metadata collection method according to the present invention. This metadata collection method is a metadata collection method for collecting metadata transmitted by the sensor terminal 11, and is characterized in that a transmission frequency is indicated to the sensor terminal 11 for each type of the metadata on the basis of the types of the metadata (step S01), and the frequency at which the sensor terminal 11 transmits the metadata is made different for each type of the metadata (step S02).

Conventionally, metadata excessively transmitted from a sensor terminal increases a load and power consumption. However, according to this metadata collection method, the transmission of metadata can be reduced to an appropriate frequency according to the type of the metadata, and the load and the power consumption can be reduced.

### Third Embodiment

The data collection device 12 described above can also be implemented by a computer and a program, and the program can be recorded in a recording medium or provided through a network.

FIG. 11 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area connected across boundaries of cities, rural areas, or countries, and (f) the Internet. Communication is performed by an electronic signal and an optical signal via the network 135.

The computer 105 includes a processor 110 and a memory 115 connected to the processor 110. The computer 105 is represented herein as a standalone device, but is not limited thereto, and may be connected to other devices (not illustrated) in a distributed processing system.

The processor 110 is an electronic device including logic circuitry that responds to and executes instructions.

The memory 115 is a tangible computer readable storage medium in which a computer program is encoded. In this regard, the memory 115 stores data and instructions, i.e., program codes, that are readable and executable by the processor 110 to control the operation of the processor 110. The memory 115 can be implemented by a random access memory (RAM), a hard drive, a read-only memory (ROM), or a combination thereof. One of the components of the memory 115 is a program module 120.

The program module 120 includes instructions for controlling the processor 110 to perform processes described herein. In the present specification, it is described that operations are executed by the computer 105, a method, a process, or a sub-process thereof. However, the operations are actually executed by the processor 110.

The term “module” is used herein to refer to a functional operation that may be embodied either as a stand-alone component or as an integrated configuration of a plurality of sub-components. Therefore, the program module 120 can be implemented as a single module or as a plurality of modules that operate in cooperation with each other. Furthermore, although the program module 120 is described herein as being installed in the memory 115 and thus implemented in software, the program module 120 can be implemented in any of hardware (for example, an electronic circuit), firmware, software, or a combination thereof.

Although the program module 120 is shown as already loaded into the memory 115, the program module 120 may be configured to be located on a storage device 140 so as to be subsequently loaded into the memory 115. The storage device 140 is a tangible computer readable storage medium that stores the program module 120. Examples of the storage device 140 include a compact disk, a magnetic tape, a read-only memory, an optical storage medium, a hard drive or a memory unit including a plurality of parallel hard drives, and a universal serial bus (USB) flash drive. Alternatively, the storage device 140 may be a random access memory or another type of electronic storage device located in a remote storage system (not illustrated) and connected to the computer 105 via the network 135.

The system 100 further includes a data source 150A and a data source 150B collectively referred to herein as a data source 150, and communicatively connected to the network 135. In practice, the data source 150 may include any number of data sources, i.e., one or more data sources. The data source 150 may include unstructured data and may include social media.

The system 100 further includes a user device 130 operated by a user 101 and connected to the computer 105 via the network 135. The user device 130 includes an input device, such as a keyboard or a voice recognition subsystem, for enabling the user 101 to communicate information and command selections to the processor 110. The user device 130 further includes an output device such as a display device, a printer, or a speech synthesizer. A cursor control unit such as a mouse, a trackball, or a touch-sensitive screen allows the user 101 to manipulate a cursor on the display device to communicate further information and command selections to the processor 110.

The processor 110 outputs a result 122 of execution of the program module 120 to the user device 130. Alternatively, the processor 110 can provide the output to a storage device 125 such as a database or memory or to a remote device (not illustrated) via the network 135.

For example, a program that performs processing illustrated in the flowchart of FIG. 6 may be used as the program module 120. The system 100 can be operated as the data collection device 12.

The term “comprise . . . ” or “comprising . . . ” specifies that the mentioned features, integers, steps, or components are present, but should be construed as not excluding the presence of one or more other features, integers, steps, or components, or groups thereof. The terms “a” and “an” are indefinite articles for an object and therefore do not exclude embodiments having a plurality of objects.

### OTHER EMBODIMENTS

Note that the present invention is not limited to the above embodiments, and various modifications can be made without departing from the gist of the present invention. In short, the present invention is not limited to the high-order embodiments as they are, and can be embodied by modifying the components without departing from the gist of the present invention at the implementation stage.

In addition, various inventions can be made by appropriately combining a plurality of components disclosed in the above embodiments. For example, some components may be deleted from all the components shown in the embodiments. Furthermore, components in different embodiments may be appropriately combined.

### REFERENCE SIGNS LIST

11, 21 Sensor terminal
11a Sensor device
11b Device information storage processing unit
11c Sensing data storage processing unit
11d Protocol operation unit (transmission/reception unit)
11e Detection unit
11e_Position information detection unit
11e₂ Installer detection unit
11e₃ Environment information detection unit
11f Metadata storage processing unit
12 Data collection device
12a Protocol operation unit
12b Collected data processing unit
12c Data batch transmission unit
12d Controller
13 Access point
100 System
101 User
105 Computer
110 Processor
115 Memory
120 Program module
122 Result
125 Storage device
130 User device
135 Network
140 Storage device
150 Data source
301 Data collection system

1. A data collection device configured to collect metadata transmitted by a sensor terminal, the data collection device comprising
a controller configured to indicate, to the sensor terminal, a transmission frequency for each type of the metadata on a basis of types of the metadata.

2. The data collection device according to claim 1, wherein the controller is configured to not indicate, to the sensor terminal, the transmission frequency for a certain period of time.

3. A sensor terminal configured to transmit metadata to a data collection device, the sensor terminal comprising
a transmitter configured to make a frequency of transmission different for each kind of the metadata according to a transmission frequency for each kind of the metadata indicated by the data collection device.

4. The sensor terminal according to claim 3, wherein the transmitter is configured to discard the metadata that has failed to be transmitted to the data collection device.

5. (canceled)

6. A metadata collection method for collecting metadata transmitted by a sensor terminal, the metadata collection method comprising:
indicating, to the sensor terminal, a transmission frequency for each type of the metadata on a basis of types of the metadata; and making a frequency at which the sensor terminal transmits the metadata different for each type of the metadata.

7. The metadata collection method according to claim 6, wherein the transmission frequency is not indicated to the sensor terminal for a certain period of time.

8. (canceled)
